(19) United States
(12) Patent Application Publication
(10) Pub. No.: US 2007/0150412 A1
(43) Pub. Date: Jun. 28, 2007

(54) Apparatus and method of providing a transaction screen

(76) Inventors: Drew Lamparello, Tega Cay, SC (US); Robert Pill, Moorpark, CA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/321,723

(22) Filed: Dec. 28, 2005

(51) Int. Cl. G06Q 40/00; G06K 9/00

(52) U.S. Cl. 705/39; 705/45; 382/137

(57) ABSTRACT

An apparatus and a method for selectively providing a teller with a transaction screen is disclosed. The apparatus includes a document input device, a screen transaction selector, and a screen generator. The document input device captures content from received documents. The screen transaction selector uses at least a portion of the captured content to select a transaction screen. The screen generator generates the selected transaction screen.

### TECHNICAL FIELD

The present invention is generally related to financial institutions and, more particularly, is related to an apparatus and method for providing transaction screens.

### BACKGROUND OF THE INVENTION

Recently enacted legislation, The Check Clearing for the 21st Century Act, 12 U.S.C. 5001, authorizes financial institutions to truncate checks and exchange images instead of paper checks. This law also allows for the creation of substitute checks or IRDs (Image replacement documents). In other words, a financial institution that receives a check may create an IRD of the received check, and then the IRD will be transmitted to other financial institutions for processing. The intent of the law was to reduce the cost and time for processing checks by capitalizing on technological advancements that make paper checks superfluous.

So as to realize cost savings due to greater efficiency and to facilitate faster processing time many of the transactions, beyond mere check processing, among financial institutions are done electronically in a paper free of virtually paper free environment.

However, even though at the back end of a financial institution many transactions are handled in a paperless manner or virtually paperless manner, the front-end transactions of the financial institution involve paper documents that the financial institution must then process.

Thus, there is a need in the art for a system that reduces processing of paper documents involved in transaction so as to promote efficiency and cost savings.

Thus, a heretofore unaddressed need exists in the industry to address the aforementioned deficiencies and inadequacies.

### SUMMARY OF THE INVENTION

Embodiments of the present invention provide an apparatus and a method for selectively providing transaction screens.

Briefly described, in architecture, one embodiment of the apparatus, among others, can be implemented as follows. The apparatus includes a document input device, a screen transaction selector module, and a screen generator. The document input device receives a paper document and generates a virtual document therefrom. The screen transaction selector module that uses at least a portion content captured by the document input device to select a transaction screen. The screen generator generates the transaction screen selected by the screen transaction selector module.

Embodiment of the present invention can also be viewed as providing methods of selectively providing financial services. In this regard, one embodiment of such a method, among others, can be broadly summarized by the following steps: capturing content from a document, wherein the captured content is in an electronic format; processing at least a portion of the captured content; selecting a type of financial transaction based at least upon the processed content; and generating a transaction screen, wherein the generated transaction screen corresponds to the selected type of financial transaction.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of a financial institution.

FIG. 2 is a block diagram of a workstation.

FIG. 3 is a flow chart of for selectively providing a transaction screen.

FIG. 4 is an illustration of an input screen.

FIG. 5 is an illustration of a transaction screen.

FIG. 6 is a flow chart of steps performed at the financial institution.

### DETAILED DESCRIPTION OF THE PREFERRED EMBODIMENT

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

Referring to FIG. 1, a financial institution 100 includes a server 102 and a plurality of workstations 104 and 106, which are in communication with each other by a network 107. Among other things, the server 102 may provide a communication link to other institutions such as, but not limited to, other financial institutions (not shown) and check clearing house institutions (not shown). In addition, the server 102 may also manage financial accounts 108, which belong to users of the financial institution 100.

The workstations 104 and 106 are in communication with the server 102. Among other things, the workstations 104 and 106 provide financial account information to the server 102 and receive financial account information from the server 102. For example, when a user (not shown) of the financial institution 100 engages a teller (not shown) to deposit a check and receive cash back, the teller may use the workstation 104 to retrieve financial account information such as the current balance of the user's financial account. The teller may then complete the transaction with the user by, among other things, providing the user cash back and crediting the balance of the check to the user's financial account. The workstation 104 communicates transaction information to the server 102 such that the user's financial account 108 may be updated.

Conceptually, the financial institution 100 is comprised of a front-end 110 and a back-end 112. The front-end 110 may comprise components and processes that are directly engaged by a user of the financial institution 100 such as, but not limited to, the workstation 104, which is manned by a teller (not shown). The back-end 112 of the financial institution may be comprised of all of the other components and processes of the financial institution 100. In one embodiment, a user of the financial institution 100 may provide a teller with paper documents such as, but not limited to, checks, deposit slips, withdrawal slips, payment coupons, etc., so as to conduct a transaction at the financial institution. The teller using the workstation 104 may generate electronic “virtual documents,” which may be considered to include electronic copies of the received documents, wherein the electronic copies might full copies, or in some embodiments, partial copies. In one embodiment, the virtual documents may then be passed from the front-end 110 to the back-end 112, where the transaction is completed/processed in a paper-less environment. In another embodiment, the back-end 112 uses virtual documents to complete/process transactions a generally paper-less environment.

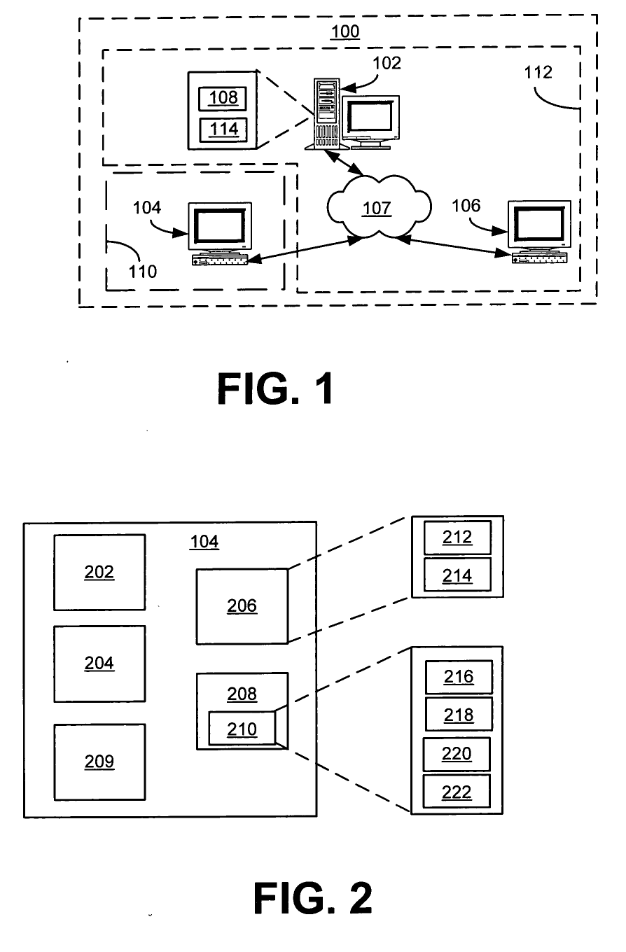

Referring to FIG. 2, the workstation 104 includes a display device 202 and a teller input device 204. The teller input device 204 is used by a teller for inputting information and the display device is used for displaying information. Non-limiting examples of input devices include, keyboards, keyboards with cursor controller such as a mouse, touchpad, etc., stylus and pen, and other input devices. Non-limiting examples of display devices include monitors. Input devices and display devices are well known in the art and, consequently, are not discussed in detail.

In some embodiments, the workstation 104 comprises a computer system having a memory 208 and a processor 209. In some embodiments, the workstation 104 may be a personal computer, and in other embodiments, the workstation 104 comprises a client of the server 102. Further details regarding the architecture of the workstation 104 and/or the server 102 can be found in U.S. patent application Ser. No. 10/907,199 and U.S. patent application Ser. No. 10/907,252, both of which are hereby incorporated by reference in their entirety. It should be remembered that the workstation 104 can be embodied in a “workstation” and/or a “thin client” as described in the aforementioned U.S. Patent Applications.

The workstation 104 also includes a document input device (DID) 206, which includes a Magnetic Ink Character Reader (MICR) 212 and an optical scanner 214. Optical scanners and MICRs are well known in the art and will not be discussed in detail.

The DID 206 is configured to receive documents such as, but not limited to, deposit slips, withdrawal slips, checks, money orders, payment stubs and/or payment coupons, and other documents. In one embodiment, the optical scanner 214 is configured to scan one and/or both sides of a document and to capture an image of each scanned side of the document. The MICR 212 is configured to read magnetic ink, which is frequently used in financial papers such as, but not limited to, bank checks. The DID 206 is configured to provide the application module 210 with information captured from documents received by the DID 206. Captured information comprises information read from the MICR 212 and image information from the optical scanner 214. In some embodiments, the optical scanner can also include an Optical Character Recognition (OCR) module, which can read and recognize characters from a scanned image.

Consequently, in some embodiments, captured information may also include characters read by the scanner 214.

Some or all of the information captured by the DID 206 can be used to generate a “virtual” document. The workstation 104 is configured to transmit at least some of the captured information to the server 102, and/or to the workstation 106, and/or to other financial institutions. It is an aspect of the present invention that virtual documents can be electronically transmitted such that different types of transactions that occur at the workstation 104 can be processed at the financial institution 100 in a paperless fashion.

Referring to FIG. 1, in some embodiments, the server 102 may include a repository 118 of “front-end completed transactions,” wherein for the purposes of this disclosure a front-end completed transaction is comprised of virtual documents that form a transaction that was completed at the workstation 104. Typically, even though the transaction has been completed at the front-end 110 of the financial institution 100, the transaction will require further processing at the back-end 112. The repository 118 can be accessed by the workstation 106 (and by other components of the back-end 112). A user of the workstation 106 may use the workstation 106 to further process the front-end completed transactions. It should be noted that because the repository 114 holds all of the virtual documents that comprise the front-end completed transaction, the transaction may be completed, with respect to back-end processing, using the virtual documents. In preferred embodiments, the back-end processing is completed in a paper-less or virtually paper-less environment.

The memory 208 includes an application module 210 having an OCR module 216, a screen transaction selector (STS) module 218, a screen generator module 220, and a communication module 222. Typically, the application module 210 is comprised of software, programming, logic segments, etc., which are executed by the processor 209.

The communication module 222 is configured to, among other things, communicate with at least the server 102. In some embodiments, the communication module 222 can be used to communicate with the workstation 106 and/or with other workstations and/or with other servers including servers that are not part of the financial institution 100. Thus, the communication module frequently provides virtual documents to the back-end 112 . Typically, the virtual documents that comprise a transaction are processed at the back-end 112 in a paper-less or generally paper-less environment.

The OCR module 216 receives captured images of scanned documents and is configured to, among other things, recognize alpha-numeric characters in the images. Typically, the OCR module is configured to recognize alpha-numeric characters that are handwritten and/or generated by a machine using a “handwriting” font. Typically, the OCR module 216 can recognize the amounts that are written as numeric characters into the “COURTESY” portion of a bank check. In some embodiments, the OCR module 216 is configured to recognize cursive characters and/or printed characters. Thus, in some embodiments, the OCR 216 can recognize amounts written into the “LEGAL AMOUNT” portion, i.e., the portion of a bank check where the amount is represented using alphabetic characters , wherein the alphabetic characters may be cursive characters, printed characters, handwritten, or machine font.

The screen generator module 220 is configured to generate screens that are displayed on the display device 202. The screens generally correspond to a type of financial transaction. Typically, a teller may handle many different types of transactions such as, but not limited to, depositing checks and/or cash into an account such as a savings account or checking account or certificate of deposit account; receiving checks for deposit into an account and providing cash back; cashing a check; receiving payment such as a mortgage payment; providing a cashier's check; and providing traveler's checks. Because the teller handles many types of transactions, and different transactions involve different input, the screen generator 220 is configured to generate a screen (or screens) that is appropriate for the transaction in which the teller is currently engaged.

The screen transaction selection module 218 receives captured information, and as previously described hereinabove, the captured information includes, but is not limited to, images of scanned documents, recognized characters from the OCR module 216, and character information from the MICR 212. It should be remembered that the OCR module 216 can be embodied in the optical scanner 214. The screen transaction selection 218 module is configured to, among other things, use the received information to determine which transaction screen to select based at least upon the captured information. As an example, if the user of the financial institution 100 had provided the teller with a check deposit slip and checks, the screen transaction selection module would process the captured information to determine that the transaction involved a check deposit. In embodiment, the OCR 216 would recognize key words on the deposit slip, and the screen transaction selection module 218 would use those key words, among other things, to determine that the transaction involved a deposit into a checking account. The checking account into which the checks should be deposited could be determined by information captured by the MICR 212. Furthermore, the OCR 216 could also recognize the amounts of the checks for deposit and the amount, if any, for cash back—the cash back amount is normally written on the deposit slip.

In one embodiment, the screen transaction selection module 218 may be configured to determine the types of transactions using at least images of the scanned documents. In other embodiments, the screen transaction selection module may be configured to determine the type of transactions using at least a portion of read content. Typically, many documents of a similar type have similar characteristics, and the characteristics can be used by the screen transaction selection module 218 to determine the appropriate screen. For example, payment stubs or coupons from a payment book such as, but not limited to, mortgage payment coupons may have similar characteristics or similar content or similar strings of content, which may be different from other types of documents such as deposit slips and/or withdrawal slips, etc., and the similarities can be used to distinguish the payment stubs from other documents. For example, a payment stub may include content such as, but not limited to, “payment due date,” “minimum monthly amount,” “amount paid,” “account number,” name of payee, name of payer, address of payee, etc.

The screen transaction selection module 218 communicates to the screen generator 220 which screen has been selected, and the screen generator 220 then generates the selected screen. It should be noted that in some embodiments, the screen generator module 220 populates fields within the screens that it generates. The screen generator module 220 receives information from at least the OCR 216 and the MICR 214 and determines which information included in the received information corresponds to a field in the screen to be generated and then, if possible, populates at least one of the fields in the screen accordingly.

It should be remembered that the workstation 104 can be configured as a client of the server 102. Thus, in some embodiments, one or more of the applications 210 may be hosted on the server 102. For example, in one embodiment, the DID 206 may provide the server 102 with captured content, and the server 102 may logic such as an OCR module for processing captured content. The server 102 may also include screen transaction selection module. Thus, the server 102 can be configured to receive information such as, but not limited to, captured content and/or teller input and select a transaction screen using the received information. The server 102 may also be configured to tell the workstation 104 which transaction screen has been selected.

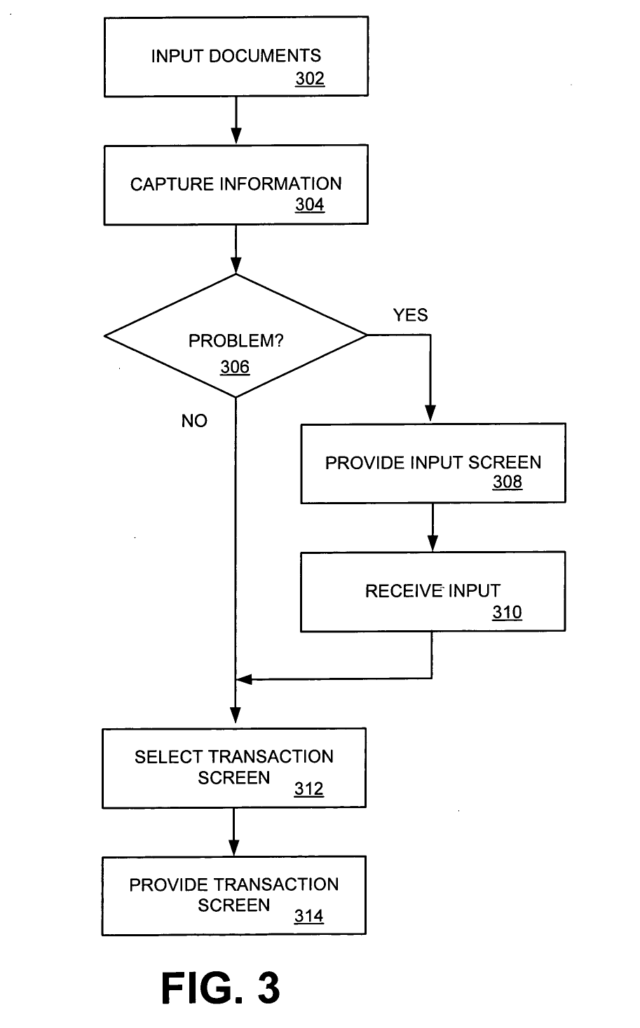

FIG. 3 illustrates an exemplary flow chart of steps performed at the financial institution 100. In step 302, the teller inputs one or more documents, which received from a user of the financial institution 100, into the DID 206.

In step 304, the DID 206 captures content from the documents by scanning the documents. The captured content may include, but is not limited to, content from the MICR 212, images from the optical scanner 214, and content from the OCR 216. It should be remembered that OCR 216 can be included in as a module of the optical scanner 214 and/or the DID 206.

In step 306, a determination is made as to whether there is a problem with the input documents and/or with selecting a transaction screen. For example, if the OCR 216 cannot read content from a virtual document, then the OCR 216 determines that there is a problem. The MICR 212 can also determine that there is a problem when it has difficulty reading magnetic ink characters. Similarly, the STS 218 can determine there is a problem when it cannot ascertain, based upon captured information, the type of transaction desired by the user.

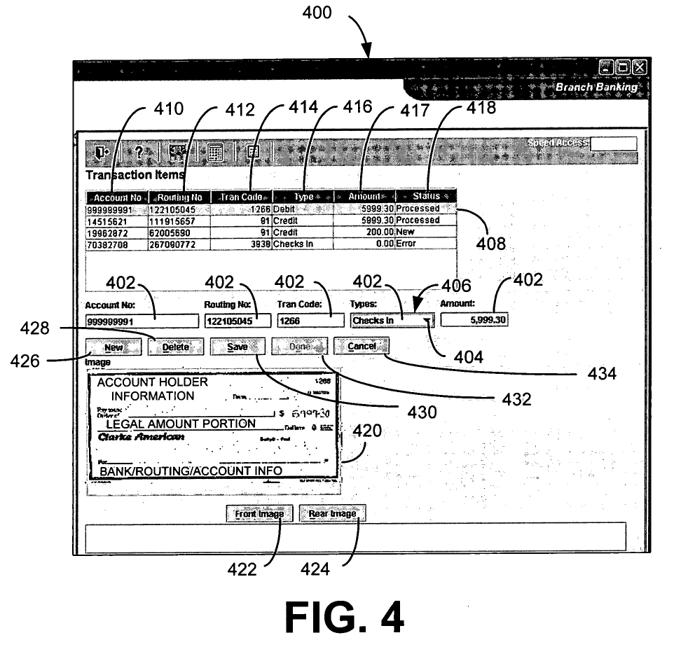

If there is a problem in step 308, then the process continues at step 308 where the screen generator 220 provides the teller with an input screen 400, which is illustrated in FIG. 4. The input screen 400 includes a plurality of editable fields 402 and, in some embodiments, may also include a pull down tab 404, which provides a menu of transaction types. The pull down tab 404 may be used to populate a transaction type field 406, which is typically pre-populated by the screen generator 220. Typically, the input screen 400 is used for, among other things, enabling the teller to verify the accuracy of information read from the captured content, edit fields, and process transactions.

In step 310, the teller input is received. The teller input is typically received by a teller positioning a cursor on a portion of a screen and selecting that portion by clicking on a mouse button. Alternatively, the teller can move the cursor among the fields of the screen by “tabbing.” It should be noted that the teller input can include editing fields and/or selecting transactions.

In step 312, the appropriate transaction screen is selected. The appropriate transaction screen may be selected based solely on captured information. In other embodiments, the appropriate transaction screen is selected based on a combination of captured information and teller input. In other embodiments, the appropriate transaction screen is selected based upon teller input.

Next in step 314, the transaction screen is provided to the teller. The transaction screen corresponds to the type of transaction that was selected by either the teller using the input screen 400 or by the screen transaction selection module 218.

It should be noted that in some embodiments, the step 306, among others, is an optional step. In some embodiments, the input screen 400 can be a default screen that is provided to the teller even when there is no problem with selecting a transaction screen or with the virtual documents. Thus, in some embodiments, the input screen may be provided to the teller so that the teller can use the input screen to, among other things, verify the accuracy of the virtual documents and/or verify the selected type of transaction.

FIG. 4 illustrates an exemplary input screen 400. The input screen 400 includes a window 408 that has table of virtual documents. Captured information from a document is displayed horizontally and is categorized vertically. Thus, the columns 410, 412, 414, 416, 417, and 418 corresponds to “Account No.”, “Routing No.”, “Transaction Code”, “Transaction Type”, “Amount”, and “Status”, respectively. Entries in these columns may be pre-populated with captured information. The teller can use the window 408 to, among other things, verify captured information and verify the type of transaction. Among other things, the status column 418 can display whether there is an error with captured information.

The teller can select a row of entries and some or all of the entries are then displayed in the editable fields 402. By selecting a row entries, the teller can edit the entries displayed in window 408. In some embodiments, the input screen 400 also includes an image window 420. The image window 420 displays one side or the other side of a virtual document, the displayed virtual document corresponds to whichever row of entries is currently selected. The teller may use buttons 422 and 424 for selecting the front or rear views of the virtual document, respectively.

The input screen 400 also includes input buttons 426, 428, 430, 432, and 434.

The button 426 may be used to add another row of entries to the table 408. Information for the new row of entries can be inputted by the teller using the input device 304 and/or from the DID 206. The teller may use button 428 to delete a row of entries and button 430 to save information comprising a row of entries. Buttons 432 and 434 may be used to process a transaction and to cancel a transaction, respectively.

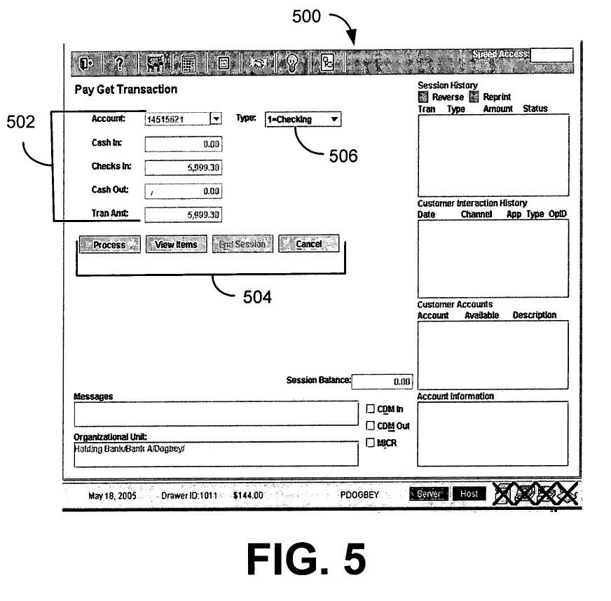

FIG. 5 illustrates an exemplary transaction screen 500. The transaction screen 500 includes a plurality of windows 502. Generally, the fields 502 carry pre-populated information corresponding to information from the input screen 400. However, in some embodiments, the information carried by the fields 502 corresponds to captured information. The transaction screen 500 also includes a plurality of buttons 504, which the teller may use for selecting various actions such as, processing the transaction, viewing items that comprise the transaction, ending a session with the user of the financial institution, and canceling the current transaction. The transaction screen 500 may also include a transaction type window 506 for displaying the type of transaction being conducted. If needed the teller may use the transaction type window 506 for selecting another type of transaction.

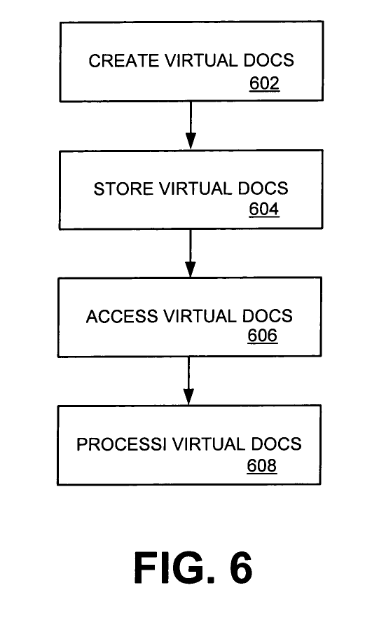

FIG. 6 is a flow chart of steps performed at the financial institution 100. In step 602, the virtual documents for a transaction are created. The virtual documents are created by the DID 206. The workstation 104 passes the virtual documents to the repository 114 where they are stored in step 604. Once the virtual documents are stored in the repository, the front-end 110 has completed its portion of the processing of the transaction.

In step 606, the virtual documents are accessed by a component of the back-end 112. Typically, a workstation such as workstation 106 is used to access the virtual documents. In step 608, the user of the workstation finishes processing the transaction using the virtual documents.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A method of providing financial services, the method comprising the steps of:
capturing content from a document, wherein the captured content is in an electronic format;
processing at least a portion of the captured content;
selecting a type of financial transaction based at least upon the processed content;
generating a transaction screen, wherein the generated transaction screen corresponds to the selected type of financial transaction.

2. The method of claim 1, further including the step of:
populating fields in the transaction screen with captured information.

3. The method of claim 2, further including the step of:
providing an input screen; and
displaying in the input screen captured content.

4. The method of claim 3, further including the step of:
enabling a user to edit information displayed in the input screen.

5. The method of claim 1, further including the steps of:
generating a virtual document from the captured information; and
storing the virtual document in a repository.

6. The method of claim 5, further including the steps of:
retrieving the virtual document, wherein the virtual document is related to a specific transaction; and
completing the processing of the specific transaction using the virtual document.

7. The method of claim 1, further including the step of:
receiving user input, wherein the user input is used in the step of selecting a transaction window.

8. An apparatus used in financial transactions, the apparatus comprising:
a document input device, wherein the document input device receives a paper document and generates a virtual document therefrom;
a screen transaction selector module that uses at least a portion content captured by the document input device to select a transaction screen; and
a screen generator, wherein the screen generator generates the selected transaction screen.

9. The apparatus of claim 8, further including:
a communication module that provides the virtual document to a repository.

10. The apparatus of claim 8, wherein the document input device includes an optical scanner.

11. The system of claim 8, wherein the document input device includes magnetic ink character reader.

12. The system of claim 8, wherein the screen generator is configured to display an input screen, wherein content captured by the document input device is displayed in a field of the input screen.

13. The system of claim 12, wherein the field is edittable.

14. The system of claim 8, wherein the input screen provides a window that enables a user to provide input related to a transaction type.

15. The system of claim 14, wherein the screen transaction selector uses the user input in selecting a transaction screen.
